(19) United States
(12) Patent Application Publication
(10) Pub. No.: US 2011/0251927 A1
(43) Pub. Date: Oct. 13, 2011

(54) PRECIOUS METALS DISTRIBUTION WEBSITE

(76) Inventor: Richard E. Gless, II, Bettendorf, IA (US)

(21) Appl. No.: 12/839,539

(22) Filed: Jul. 20, 2010

Related U.S. Application Data
(60) Provisional application No. 61/323,519, filed on Apr. 13, 2010.

(51) Int. Cl. G06Q 30/00

(52) U.S. Cl. 705/27.1; 705/26.1

(57) ABSTRACT

A distribution channel of precious metals utilizes an investment agent and/or insurance agent model. A method for purchasing and selling precious metals may be a web-based trading model that may allow individuals to conveniently trade precious metals. A monthly accumulation plan may allow clients to develop a portfolio in precious metals.

### CROSS-REFERENCE TO RELATED APPLICATIONS

The present application claims the benefit of priority to U.S. provisional patent application No. 61/323,519, filed Apr. 13, 2010, herein incorporated by reference in its entirety.

### BACKGROUND OF THE INVENTION

The present invention relates to commodity trading and, more particularly, to an apparatus and method for precious metal buying and selling.

Currently, there are no convenient methods for individual agents, advisors, or the like to buy and sell precious metals, such as gold, silver, platinum and the like. Moreover, there are no convenient portals for agents to make purchases and/or sales of precious metals.

As can be seen, there is a need for a distribution channel of precious metals and a method for the purchase and sale of precious metals.

### SUMMARY OF THE INVENTION

In one aspect of the present invention, a precious metals distribution system comprises an electronic data portal allowing an independent contractor to sign in; a purchasing module adapted to receive a purchase order from the independent contractor to purchase precious metals; and a selling module adapted to receive a sales order from the independent contractor to sell precious metals, wherein the electronic data portal receives the purchase order or sales order from the independent contractor and forwards the order to a website owner.

In another aspect of the present invention, an on-line web portal for buying and selling precious metals comprises a sign-in screen permitting a trusted agent or trusted advisor to sign into the web portal; a purchasing module adapted to receive a purchase order from the signed-in trusted agent or trusted advisor to purchase precious metals; a selling module adapted to receive a sales order from the signed-in trusted agent or trusted advisor to sell precious metals, wherein the web portal receives the purchase order or sales order from the independent contractor and forwards the order to a website owner.

In a further aspect of the present invention, a method for buying or selling precious metals comprises receiving a purchase order or a sales order from a client; signing into an electronic data portal; selecting items for purchase or items for sale; generating a purchase request or a sales request from the items selected; and sending the purchase request or sales request to an owner, or delegate thereof, of the electronic data portal.

These and other features, aspects and advantages of the present invention will become better understood with reference to the following drawings, description and claims.

### BRIEF DESCRIPTION OF THE DRAWINGS

FIG. 1 is a schematic diagram of a precious metals distribution model according to one embodiment of the present invention;

FIG. 2 is a flow chart of a method for buying and selling precious metals according to another embodiment of the present invention; and

FIG. 3 is a continuation of the flow chart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a distribution channel of precious metals utilizing an investment agent and/or insurance agent model. A further embodiment of the present invention provides a method for purchasing and selling precious metals. The methods of the present invention may allow individuals to conveniently trade precious metals.

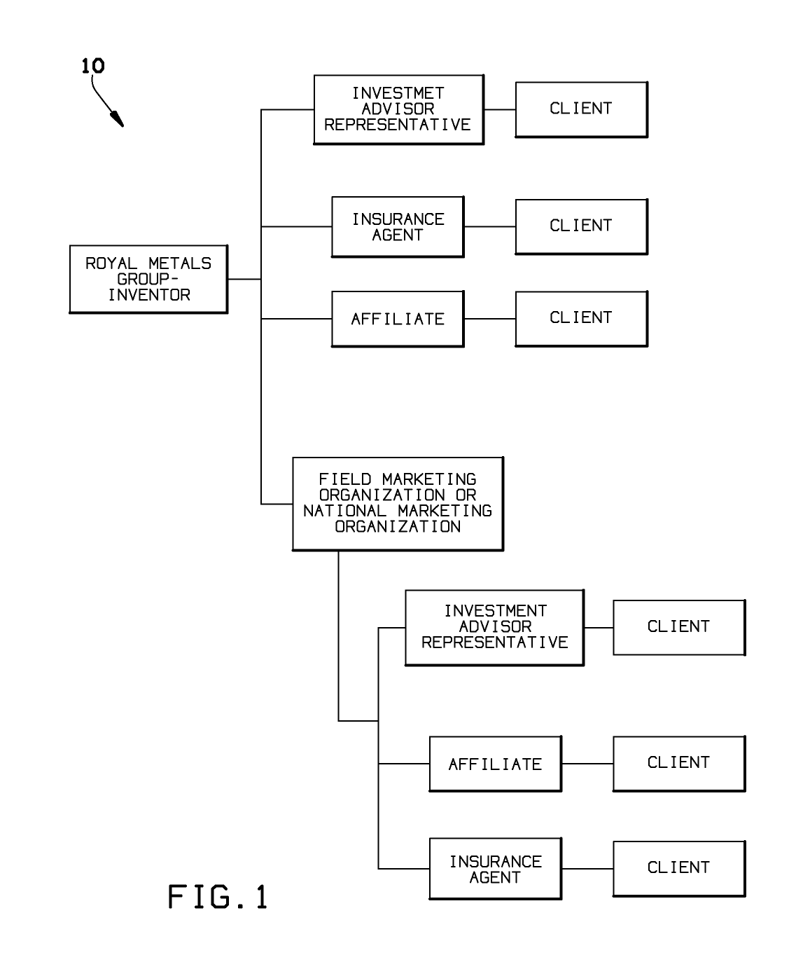

Referring to FIG. 1, a precious metals distribution system 10 may utilize an independent agent or independent advisor distribution model. For purchase orders, the insurance agent or investment advisor may be used for physical delivery of precious metals, coinage, bullion or the like (also simply referred to, collectively, as precious metals). For sale orders, the insurance agent or investment advisor may facilitate the shipping of the precious metals from the seller to centralized metals group. Clients may purchase precious metals through an automatic monthly purchase plan that may be set up between the insurance agent or investment advisor and the client/purchaser.

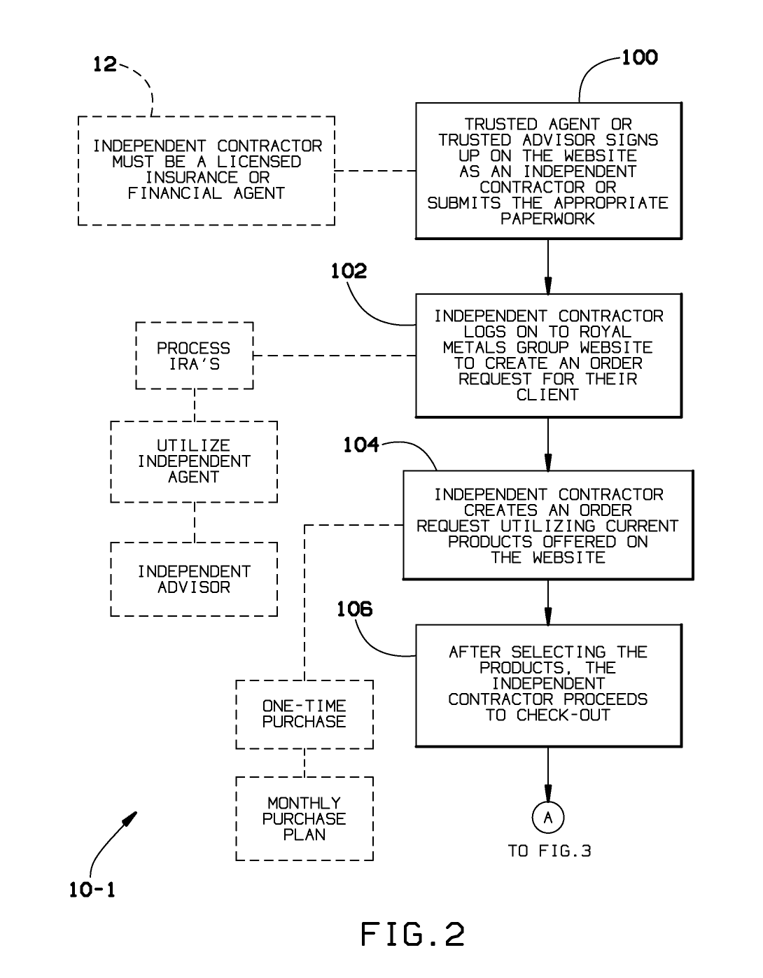

Referring to FIG. 2, a distribution method 10′ may include a step 100 where a trusted agent or trusted advisor may sign up as an independent contractor 12 at a website, or may submit agent contracting paperwork to the website owner (referred to as Royal Metals Group). In one embodiment, the independent contractor 12 may be a licensed insurance agent or financial professional to secure fiduciary responsibility to the client.

In step 102, the independent contractor 12 may log on to an electronic data portal, such as a website, to create an order or sale request for his/her client. In step 104, the independent contractor 12 may create an order or sale request for current bullion/coinage products on the website through purchase and/or sale modules. In step 106, the independent contractor 12 may proceed to checkout (e.g., shopping cart style) on behalf of the client.

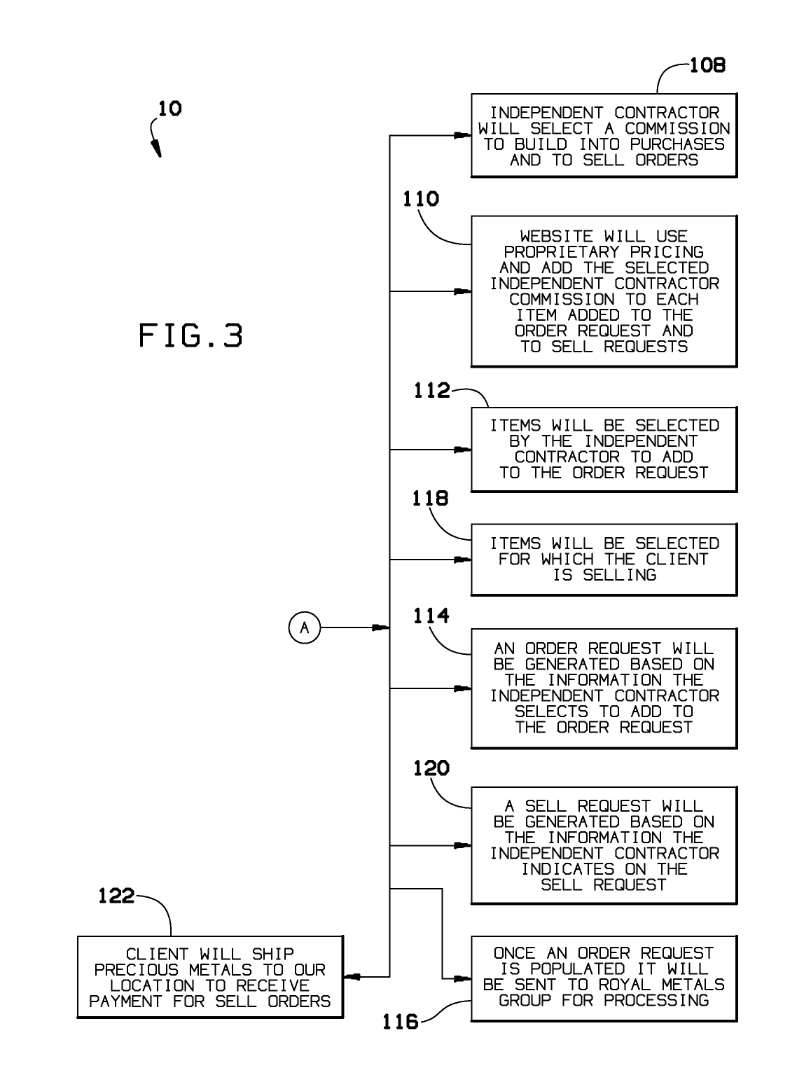

Referring now to FIG. 3, a continuation of the flow chart of FIG. 2, in step 108 the independent contractor 12 may, upon checking out, be prompted to a commission module to select a built-in commission or a commission percentage to be added to the order. The independent contractor 12 may receive a preset commission by the website owner, but may also add an additional commission, to be paid by the client, to the order. As shown on step 110, the website may use proprietary pricing and add the selected independent contractor commission to each item added to the order request and to sell requests.

For order (purchase) requests, items to be purchased may be selected by the independent contractor and added to the order request in step 112. An order request may then by generated based on the information the independent contractor selects to add to the order request, as shown in step 114. At step 116, once an order request is populated, it may be sent to Royal Metals Group (the website owner, or a delegate thereof) for processing. The independent contractor may then submit payment to Royal Metals Group (RMG) via wire transfer, cashier's check, personal check, or the like. Once the payment is received, RMG may process the order request. RMG may then ship the precious metal goods (coinage, bullion, or the like) to the client or to the independent contractor to deliver to the client.

For sale requests, the independent contractor may select the items the client is selling in step 118. Then, in step 120, a sell request may be generated based on the information the independent contractor provides on the sell request. In step 122, the client (themselves, or via the independent contractor) may ship precious metals to RMG. At that point, RMG may send payment to the seller (directly, or via the independent contractor) for the goods received.

Referring back to FIG. 2, other products may be purchased in the system 10-1, such as individual retirement accounts (IRAs) 14. The IRAs 14 may be funded by the client and the funds may be used, for example, for holding precious metals as at least a portion of the assets in the IRA. The system 10-1 may also include a method where a client may make monthly contributions and/or purchases of precious metals. For example, the client may select to deposit cash into a money market account monthly. When a threshold of cash is achieved in this account, the cash may be used to purchase precious metals. In another embodiment, the client may send cash monthly which may be used directly for the purchase of precious metals. These monthly accumulation plans may allow clients to slowly develop a portfolio of precious metals over time.

While the above description describes a precious metals trading system and method using a web-based portal, other means may be within the scope of the present invention. For example, a wide area network (WAN) may be set up between RMG and the independent contractors to provide the electronic exchange of information. In other embodiments, smart phone applications may be developed for independent contractors to communicate buy and sell orders to RMG.

It should be understood, of course, that the foregoing relates to exemplary embodiments of the invention and that modifications may be made without departing from the spirit and scope of the invention as set forth in the following claims.

What is claimed is:

1. A precious metals distribution system comprising:
an electronic data portal allowing an independent contractor to sign in;
a purchasing module adapted to receive a purchase order from the independent contractor to purchase precious metals; and
a selling module adapted to receive a sales order from the independent contractor to sell precious metals, wherein
the electronic data portal receives the purchase order or sales order from the independent contractor and forwards the order to a website owner.

2. The system of claim 1, further comprising a commission module allowing the independent contractor to either use a built-in commission or to add a desired commission to the purchase order or the sales order.

3. The system of claim 1, wherein the independent contractor is an insurance agent or an investment advisor.

4. The system of claim 1, wherein the electronic data portal is an internet website.

5. An on-line web portal for buying and selling precious metals, the web portal comprising:
a sign-in screen permitting a trusted agent or trusted advisor to sign into the web portal;
a purchasing module adapted to receive a purchase order from the signed-in trusted agent or trusted advisor to purchase precious metals;
a selling module adapted to receive a sales order from the signed-in trusted agent or trusted advisor to sell precious metals, wherein
the web portal receives the purchase order or sales order from the independent contractor and forwards the order to a website owner.

6. The web portal of claim 5, further comprising a commission module allowing the signed-in trusted agent or trusted advisor to either use a built-in commission or to add a desired commission to the purchase order or the sales order.

7. A method for buying or selling precious metals, the method comprising:
receiving a purchase order or a sales order from a client;
signing into an electronic data portal;
selecting items for purchase or items for sale;
generating a purchase request or a sales request from the items selected; and
sending the purchase request or sales request to an owner, or delegate thereof, of the electronic data portal.

8. The method of claim 7, further comprising adding a commission to either the purchase request or the sales request, wherein the commission is a predetermined commission or the commission is a manually entered amount.

9. The method of claim 7, further comprising delivering the precious metals to the client after receiving the purchase request and funds appropriate for the purchase request.

10. The method of claim 7, further comprising collecting a pre-determined monthly amount from the client for purchasing precious metals.
